(19) United States
(12) Patent Application Publication
(10) Pub. No.: US 2013/0314958 A1
(43) Pub. Date: Nov. 28, 2013

(54) SOFT SWITCHING POWER CONVERTERS

(71) Applicant: SunEdison LLC, Beltsville, MD (US)

(72) Inventor: Gregory Allen Kern, Redwood City, CA (US)

(21) Appl. No.: 13/900,687

(22) Filed: May 23, 2013

Related U.S. Application Data
(60) Provisional application No. 61/650,812, filed on May 23, 2012.
(60) Provisional application No. 61/793,372, filed on Mar. 15, 2013.

(51) Int. Cl. H02M 7/5387; H02J 1/10

(52) U.S. Cl. CPC H02M 7/53871; H02J 1/10
USPC 363/80; 307/43

(57) ABSTRACT

Soft switching power converters are described. In one example, a solar power converter includes an inverter input to receive a direct current (DC) power input and an output to provide an alternating current (AC) power output. The converter includes a first and a second power branch, and a controller. The first power branch includes a plurality of first switches and a first current sensor configured to generate a first current signal. The second power branch includes a plurality of second switches and a second current sensor configured to generate a second current signal. The controller is configured to control switching of the first and second plurality of switches to provide the AC power output based at least in part on the first and second current signals.

### CROSS-REFERENCE TO RELATED APPLICATIONS

This application claims priority to U.S. Provisional Application No. 61/650,812 filed May 23, 2012, and U.S. Provisional Application No. 61/793,372 filed Mar. 15, 2013, the entire disclosures of which are incorporated herein by reference.

### FIELD

This disclosure generally relates to power systems and, more specifically, to soft switching power converters.

### BACKGROUND

In some known solar power systems, a plurality of photovoltaic (PV) panels (also known as solar panels) are logically or physically grouped together to form an array of solar panels. The solar panel array converts solar energy into electrical energy. The electrical energy may be used directly, converted for local use, and/or converted and transmitted to an electrical grid or another destination.

Solar panels generally output direct current (DC) electrical power. To properly couple such solar panels to an electrical grid, or otherwise provide alternating current (AC) power, the electrical power received from the solar panels is converted from DC to AC power. At least some known solar power systems use a single stage or a two-stage power converter to convert DC power to AC power. Some such systems are controlled by a control system to maximize the power received from the solar panels and to convert the received DC power into AC power that complies with utility grid requirements.

However, at least some known solar power converters are relatively inefficient and/or unreliable. Moreover, some known solar power converters have relatively high conducted and/or radiated emissions. Accordingly, a better solution is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

One aspect of the present disclosure is a solar power converter. The solar power converter includes an inverter input for receiving a direct current (DC) power input, a first and a second power branch coupled to the inverter input, a first output inductor coupled to the first power branch, a second output inductor coupled to the second power branch, an inverter output coupled to the first and second output inductors to provide an alternating current (AC) power output, and a controller. The first power branch includes a plurality of first switches and a first current sensor. The first current sensor is configured to generate a first current signal. The second power branch includes a plurality of second switches and a second current sensor configured to generate a second current signal. The controller is configured to control switching of the first and second plurality of switches to provide the AC power output based at least in part on the first and second current signals.

Another aspect of the present disclosure is a solar power converter. The solar power converter includes an inverter input for receiving a direct current (DC) power input, a first power branch coupled to the inverter input, a second power branch coupled to the inverter input, a first output inductor coupled to the first power branch, a second output inductor coupled to the second power branch, an inverter output coupled to the first and second output inductors to provide an alternating current (AC) power output, and a controller configured to monitor a plurality of internal voltages of the solar power converter. The first power branch includes a plurality of first switches, and the second power branch includes a plurality of second switches. The controller is configured for current mode control of the first and second plurality of switches to provide the AC power output based at least in part on the monitored output voltage.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic block diagram of an example power conversion system.

FIG. 2 is a schematic diagram of an example converter for use in the system shown in FIG. 1.

FIG. 3 illustrates simulated waveform signals from the converter shown in FIG. 2.

FIG. 4 is an enlarged view of the waveform signals shown in FIG. 3.

FIG. 5 is another enlarged view of the waveform signals shown in FIG. 3.

FIG. 6 is a schematic diagram of an example converter and controls for use in the system shown in FIG. 1.

FIG. 7 is a schematic diagram of a Hi/Lo Driver for use in the converter shown in FIG. 6.

FIG. 8 is a schematic diagram of a VDS Sense circuit for use in the converter shown in FIG. 6.

FIG. 9 is a schematic diagram of a Current Sense and Compare circuit for use in the Control Logic of the converter shown in FIG. 6.

FIG. 10 is a schematic diagram of Control Logic for use in the converter shown in FIG. 6.

FIG. 11 is a timing diagram showing details of current waveform control for use in the converter shown in FIG. 6.

Like reference symbols in the various drawings indicate like elements.

### DETAILED DESCRIPTION

The embodiments described herein generally relate to power systems. More specifically embodiments described herein relate to soft switching power converters. Moreover, some embodiments described herein relate to soft switching power converters for use with a photovoltaic power source.

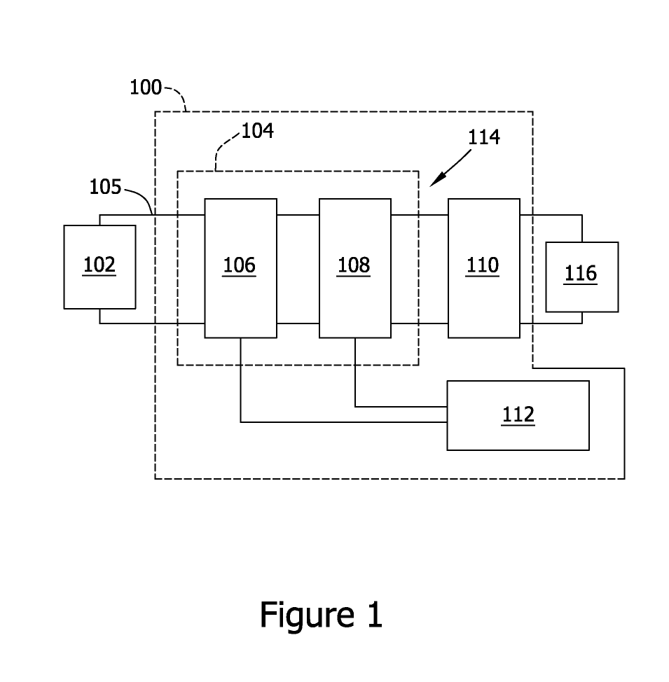

FIG. 1 is a schematic block diagram of an exemplary power conversion system 100. A power source 102 is coupled to power conversion system 100 to supply electrical current to system 100. In an exemplary embodiment, power source 102 is a photovoltaic, or “solar”, array that includes at least one photovoltaic cell. Alternatively or additionally, power source 102 includes at least one fuel cell, a direct current (DC) generator, and/or any other electric power source that enables power conversion system 100 to function as described herein.

In an exemplary embodiment, power conversion system 100 includes a power converter 104 to convert DC power received from power source 102 to an alternating current (AC) output. In other embodiments, power converter 104 may output DC power. The exemplary power converter 104 is a two stage power converter including a first stage 106 and a second stage 108. First stage 106 is a DC to DC power converter that receives a DC power input from power source 102 and outputs DC power to second stage 108. Second stage 108 is a DC to AC power converter (sometimes referred to as an inverter) that converts DC power received from first stage 106 to an AC power output. In other embodiments, power converter 104 may include more or fewer stages. More particularly, in some embodiments power converter 104 includes only second stage 108.

Power conversion system 100 also includes a filter 110, and a control system 112 that controls the operation of first stage 106 and second stage 108. Control system 112 is sometimes referred to herein as a controller. Control system 112 may include any suitable combination of analog components, digital components, integrated circuits, and/or discrete components suitable for operation as described herein. An output 114 of power converter 104 is coupled to filter 110. In an exemplary embodiment, filter 110 is coupled to an electrical distribution network 116, such as a power grid of a utility company. Accordingly, power converter 104 may be referred to as a grid tied inverter. In other embodiments, power converter 104 may be coupled to any other suitable load.

During operation, power source 102 generates a substantially direct current (DC), and a DC voltage is generated across input 105. The DC voltage and current are supplied to power converter 104. In an exemplary embodiment, control system 112 controls first stage 106 to convert the DC voltage and current to a substantially rectified DC voltage and current. The DC voltage and current output by first stage 106 may have different characteristics than the DC voltage and current received by first stage 106. For example, the magnitude of the voltage and/or current may be different. Moreover, in the exemplary embodiment, first stage 106 is an isolated converter, which operates, among other things, to isolate power source 102 from the remainder of power conversion system 100 and electrical distribution network 116. The DC voltage and current output by first stage 106 are input to second stage 108. Control system 112 controls second stage 108 to produce AC voltage and current, and to adjust a frequency, a phase, an amplitude, and/or any other characteristic of the AC voltage and/or current to match the electrical distribution network 116 characteristics. The adjusted AC voltage and/or current are transmitted to filter 110 for removing one or more undesired characteristics from the AC voltage and/or current, such as undesired frequency components and/or undesired voltage and/or current ripples. The filtered AC voltage and/or current are then supplied to electrical distribution network 116.

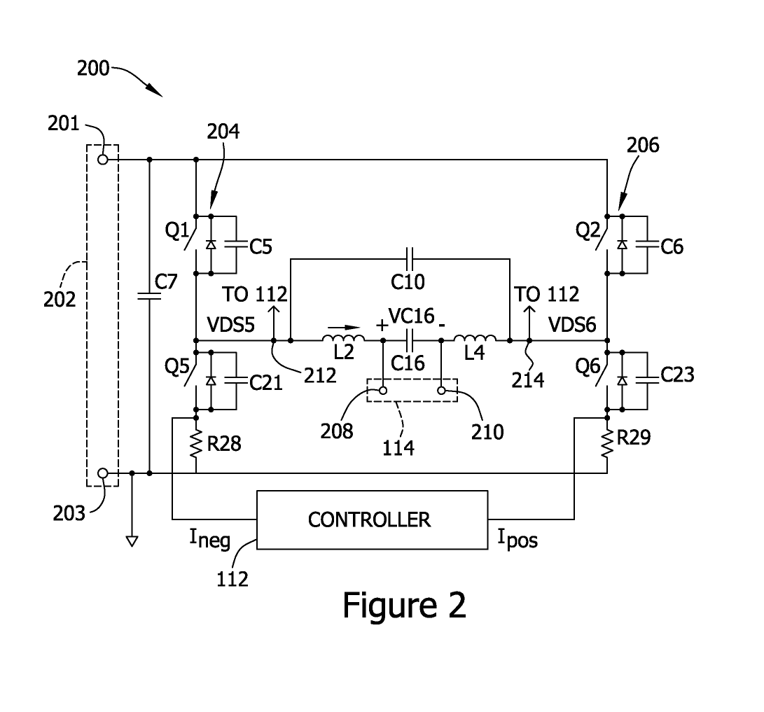

FIG. 2 is a schematic diagram of an exemplary converter 200 for use as second stage 108. Converter 200 is a soft-switching h-bridge converter. Converter 200 is operable to output DC power or AC power. In the exemplary embodiment, converter 200 is operated by control system 112 to output AC power to electrical distribution network 116. Generally, the peak output voltage of converter 200 must be less than the input voltage to converter 200. In one example embodiment, converter 200 is a 200 Watt, 120 Volt, 60 Hz grid tie converter receiving an input of 200 to 400 Vdc. In another embodiment, converter 200 is a 300 Watt, 240 Volt, 60 Hz grid tie converter receiving an input of 400 to 600 Vdc.

Converter 200 includes an input 202 for receiving DC power. Input 202 includes a DC high node 201 and a DC low node 203. DC low node 203 is the reference ground for the controller 112 circuits, but is not chassis or earth ground. An input capacitor C7 is coupled to input 202. Input capacitor C7 filters the input to converter 200 to limit switching action of the converter 200 from pulling switching currents from the power source 102 and/or first stage 106. Capacitor C7 may be one or more capacitors. In one exemplary embodiment, capacitor C7 comprises five metalized polypropylene film capacitors each rated at 5.6 uF 500 Vdc, for a total of 28.0 uF. In another example embodiment, capacitor C7 comprises one metalized polypropylene film capacitor rated at 30 uF 600 Vdc. In another exemplary embodiment, capacitor C7 comprises six metalized polypropylene film capacitors each rated at 4.7 uF 450 Vdc, for a total of 28.2 uF. In yet another embodiment, capacitor C7 comprises two metalized polypropylene film capacitors each rated at 12 uF 575 Vdc, for a total of 24 uF.

An h-bridge is coupled, via capacitor C7 to input 202. The h-bridge includes switches Q1, Q2, Q5, and Q6 and capacitors C5, C6, C21 and C23. Capacitors C5, C6, C21 and C23 may be physical capacitors added to the circuit or may be the parasitic output capacitance of the switches Q1, Q2, Q5 and Q6, or some combination of physical capacitors and parasitic capacitance. These are the main power switches in the converter 200. Switches Q1 and Q5 form a first power branch 204 of the h-bridge, and switches Q2 and Q6 form a second power branch 206 of the h-bridge. In the exemplary embodiment, switches Q1, Q2, Q5, and Q6 are metal oxide semiconductor field effect transistors (MOSFETs). In the exemplary embodiment, capacitors C5, C6, C21 and C23 are the parasitic output capacitance of switches Q1, Q2, Q5 and Q6 rather than separate capacitors. In the exemplary embodiment, switches Q1, Q2, Q5, and Q6, which are MOSFETS, have a built in body diode so an external, or discrete, diode is not needed. In other embodiments, a separate, discrete diode may, additionally or alternatively, be coupled in parallel with each switch Q1, Q2, Q5, and Q6 along with a steering diode in series with each switch Q1, Q2, Q5, and Q6. Capacitor C10 is connected between node 212 and node 214. Because the parasitic capacitances for some MOSFET switches can be small, it may be useful to add additional capacitance (i.e., capacitor C10) to the circuit. Capacitor C10 helps to slow down the switch transitions, measured in dV/dt on nodes 212 and 214. Capacitors C5, C6, C21, C23 and C10 also help to reduce any variability in circuit operation in the event of variations in output capacitance in switches Q1, Q2, Q5, and Q6. In the exemplary embodiment, switches Q1, Q2, Q5 and Q6 are IPL60R299CP MOSFETs. In an exemplary embodiment, capacitors C21 and C23 are 1000 pF capacitors and capacitor C10 is omitted.

The h-bridge is generally operated as understood by one of ordinary skill in the art. Opposing pairs of switches are alternately switched on and off to produce an AC output. More specifically, switches Q1 and Q6 are switched on and off at the same times, while switches Q2 and Q5 are switched on and off together, as well. When switches Q1 and Q6 are on, switches Q2 and Q5 are off, and vice versa. In the exemplary embodiment, switches Q1, Q2, Q5, and Q6 are switched on and off during substantially zero voltage conditions, i.e. zero voltage switching (ZVS), thereby substantially minimizing switching losses in switches Q1, Q2, Q5, and Q6. When one set of switches (i.e., Q1 and Q6, or Q2 and Q5) turn off, there is a dead time during which all switches Q1, Q2, Q5, and Q6 are off before the other set of switches (i.e., Q2 and Q5, or Q1 and Q6) turns on. This dead time allows the voltage to transition from high to low (or vice versa) to allow a zero voltage condition to develop on the opposite pair of switches (i.e. the switches that were not just turned off and are next to turn on), thereby permitting zero voltage switching.

The h-bridge is coupled to output 114. In the exemplary embodiment, output 114 includes a first output node 208 and a second output node 210. A first output inductor L2 is coupled between the h-bridge and first output node 208. More specifically, first output inductor L2 is coupled between the first power branch 204 and first output node 208. A second output inductor L4 is coupled between the h-bridge and second output node 210. More specifically, second output inductor L4 is coupled between the second power branch 206 and second output node 210. First and second output inductors L2 and L4 are the main output filter inductors for converter 200. Use of two separate inductors may reduce common mode electromagnetic emissions from the converter 200. In other embodiments, output inductors L2 and L4 may be replaced with a single inductor. In one exemplary embodiment, each output inductor L2 and L4 is rated at 300 uH, 4 Amps. In another embodiment, each output inductor L2 and L4 is rated at 1.3 mH and is made by winding 148 turns of number 20 AWG magnet wire on a magnetic core. In another embodiment, output inductors L2 and L4 may be combined into a single magnetic component with two windings on one magnetic core wound in a differential mode configuration.

An output capacitor C16 is coupled across output 114. In the exemplary embodiment, output capacitor C16 comprises a single 0.68 uF film capacitor rated for across the line application (also known as an X cap). In another example embodiment, output capacitor C16 comprises two film capacitors connected in parallel. In one example embodiment, the two film capacitors are each 0.68 uF capacitors rated for across the line application (also known as X caps). In another example embodiment, output capacitor C16 is a 0.47 uF capacitor rated for 310 Vac.

Resistors R28 and R29 are current sense resistors. More specifically, resistors R28 and R29 are two separate resistive shunts used for AC and/or DC current sensing. Two separate current sense resistors, R28 and R29, are used because it allows the controller 112 to know the polarity of the output current, hence allowing the controller 112 to determine AC and DC net output current. Generally, this would not be possible if only one single sense resistor were used between node 203 and the bottom of the two bridge power branches, 204 and 206. In the exemplary embodiment, resistors R28 and R29 are 0.025 ohms, 1 watt, non-inductive resistors. Signals from resistors R28 and R29 are used by control system 112 as feedback for controlling the output current of converter 200. Moreover, signals from resistors R28 and R29 are used for hysteretic control of output inductor L2 and L4 current to facilitate soft switching of switches Q1, Q2, Q5, and Q6, as described in more detail below. Signals from resistors R28 and R29 are amplified by amplifier circuits (not shown). The amplifier circuits provide gain and offset to the signals from resistors R28 and R29. The amplified signals are then sensed by control system 112 and sampled so that output AC and DC current can be measured and controlled. Alternatively, the signals from the two sense resistors may be provided to a single amplifier, with the output of the amplifier representing the inductor output current.

In this embodiment, when switches Q1 and Q6 are on, the output current, of converter 200, flows through R29. If the output current is positive, then a positive voltage is developed across resistor R29 and this signal, Iₚₒₛ, after amplification, is used by control system 112 as feedback for control of positive output current. When switches Q1 and Q6 are on and current is flowing through resistor R29, switches Q2 and Q5 are both off and there is no current flowing through resistor R28. When switches Q2 and Q5 are on, the output current flows through resistor R28, and no current flows through resistor R29. If the output current is negative, then a positive voltage is developed across resistor R28 and this signal, I_{neg}, after amplification, is used by control system 112 as feedback for control of negative output current. In other embodiments, positive and/or negative signals from both sense resistors are utilized as feedback by control system 112. The inclusion of current sense amplifiers and current sense resistors R28 and R29 may obviate the need for any current transformer in converter 200. Further, magnetic or hall-effect current-sensing devices, which often have problems of drift or DC output current control, may be omitted.

Control system 112 is configured to control operation of converter 200 using current mode control. More specifically, current mode control is used to control output inductor current to achieve soft switching of switches Q1, Q2, Q5, and Q6 and to generate a well-controlled sine wave output current with control of dc injection current. Generally, switches Q1, Q5, Q2, and Q6 are switched off when current through output inductors L2 and L4 are at a peak value (whether positive or negative). Further, switches Q1, Q5, Q2, and Q6 are switched on when the voltage across the switch being turned on is approximately zero volts.

In other embodiments, control system 112 controls operation of converter 200 using valley switching. In implementations where the drain to source voltage on the MOSFETs does not fully reach zero volts, the point where the drain to source voltage has reached a minimum voltage can be detected. This minimum voltage is determined when the rate of change of voltage goes from negative to positive, crossing zero. This timing should also be gated by a control circuit that looks for this minimum within a window of time after all switches have turned off. If such a minimum is not found during this window of time, then the action should be triggered anyway.

As is well known to those of ordinary skill in the art, the switching frequency of switches in a current mode controlled inverter varies during a cycle of AC output of the inverter. More specifically, the switching frequency increases as the AC output voltage nears the zero crossings and decreases as it approaches it positive and negative peaks. Operating across a range of switching frequencies is beneficial to the inverter design because it spreads the conducted emissions energy across a spectrum of frequencies. This spread spectrum effect is even more pronounced as harmonic order and frequency is increased. This makes the design of the differential mode components in the output filter 110 less expensive. This mode of operation is also beneficial in terms of conversion efficiency in that lower switching frequency occurs during times of higher instantaneous power delivery, and higher switching frequency occurs during times of lower or zero power delivery in the AC output cycle. Higher switching frequencies allow use of smaller components, such as capacitors, inductors, etc.

In one embodiment, control system 112 is configured to control operation of converter 200 using a boundary current mode (BCM) in which a fixed reverse current value is used to control soft-switching of switches Q1, Q2, Q5, and Q6. BCM control of converter 200 produces a relatively high switching frequency around the zero crossings of the output waveform of converter 200. In another example embodiment, converter 200 is controlled according to a variable hysteresis current mode (VHCM), in which a variable reverse current value is used as a basis for controlling switches Q1, Q2, Q5, and Q6. The hysteresis in the reverse current causes the reverse current to be varied between a minimum at peak output current (both positive and negative) and a maximum at the zero crossing of output current. Using a variable reverse current rather than a fixed reverse current narrows the frequency range at which switches Q1, Q2, Q5, and Q6 are switched and thereby reduces conduction losses in converter 200. In another embodiment, converter 200 is controlled according to a constant hysteresis current mode (CHCM), in which the variable current hysteresis of the VHCM control is replaced with a constant hysteresis and the hysteresis bandwidth is fixed. The constant hysteresis produces a smaller frequency range than in VHCM, at the expense of increased current around the output current zero crossings of converter 200.

In this embodiment, control system 112 is also configured to monitor the internal voltages of converter 200. Specifically, control system 112 monitors the voltages VDS5 and VDS6 at nodes 212 and 214, respectively, of converter 200. When switches Q1, Q2, Q5, and Q6 are to be turned on, control system 112 is configured to wait until the sensed voltage decreases below a voltage threshold before turning on the appropriate switches. Thus, control system 112 delays turn-on of switches Q1, Q2, Q5, and Q6 until the voltage on the respective switches to be turned-on has decreased to approximately zero to permit zero voltage switching and reduced switching losses in converter 200.

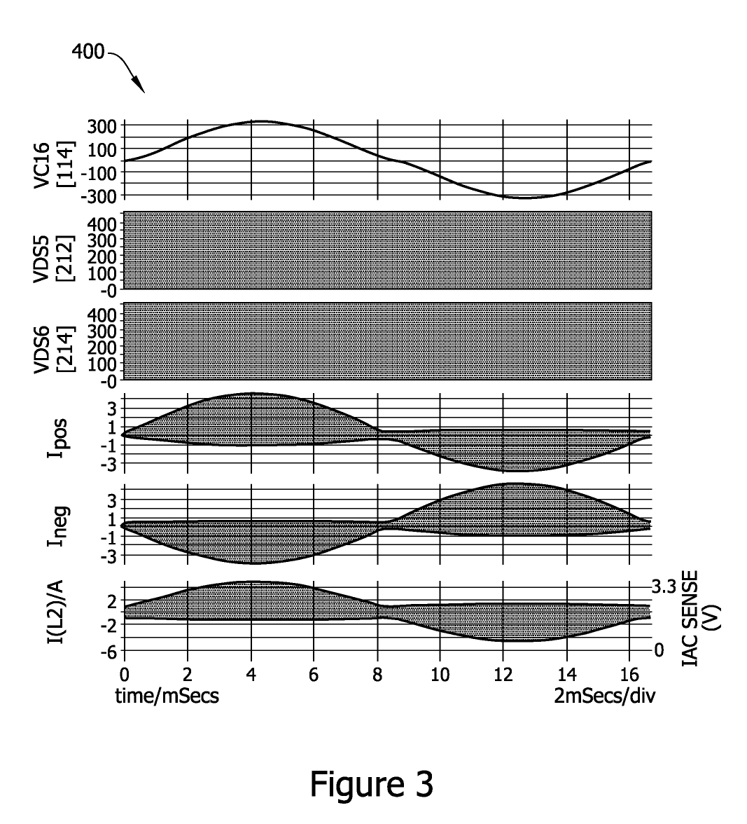

FIG. 3 is a graph 400 of a simulation of one full AC cycle of operation of converter 200. Converter 200 is operating at approximately 300 watts output power. The output voltage is approximately 240 volts AC at 60 hertz. In graph 400, VC16 is the output voltage at output 114 in volts. VDS5 is the AC voltage at node 212 in volts, and VDS6 is the AC voltage at node 214 in volts. Iₚₒₛ is the voltage across R29, while I_{neg} is the voltage across R28. I(L2) is the current through inductor L2 in amps. The inductor current waveform is also represented in the IACSENSE signal.

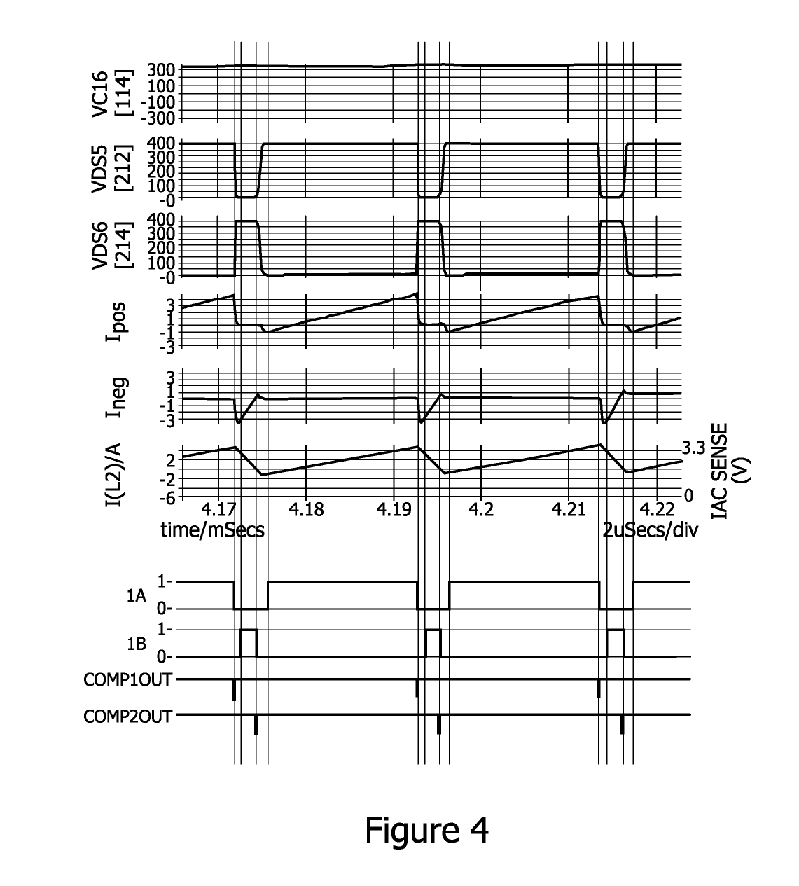

FIG. 4 is an enlarged view of graph 400 where the output waveform of converter 200 is around its peak output. Switching frequency is about 47.8 kHz and soft switching is clearly achieved. In other embodiments, other switching frequencies are used. Preferably, a relatively high switching frequency is employed, for example between about 20 kHz and 300 kHz.

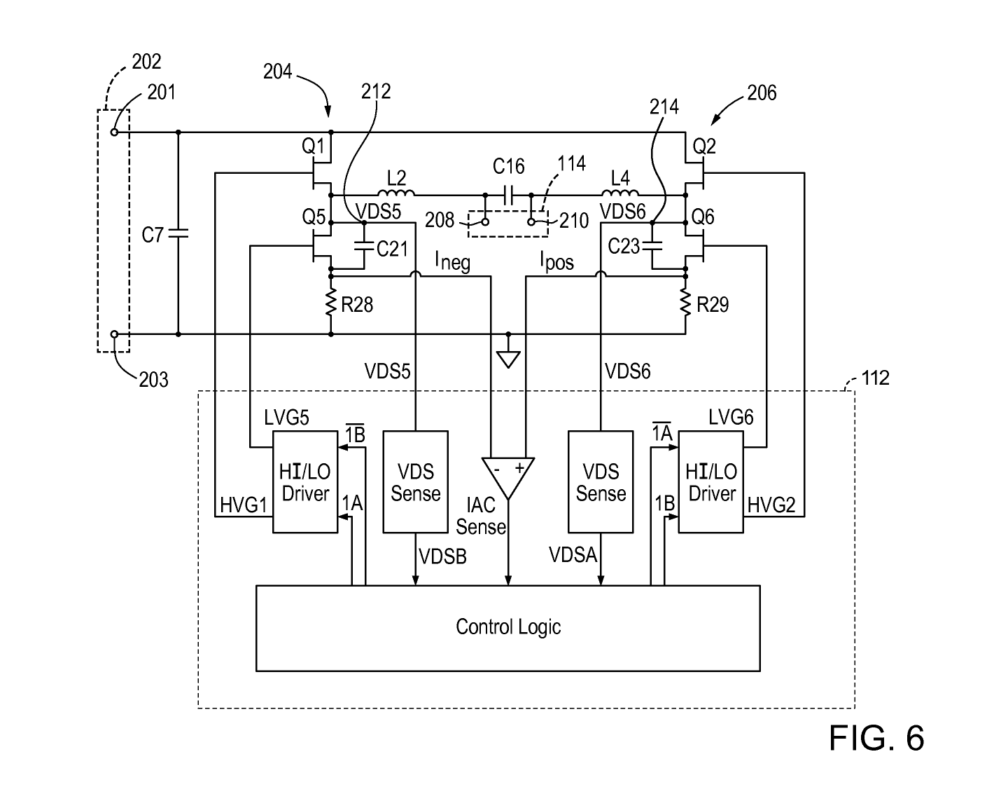

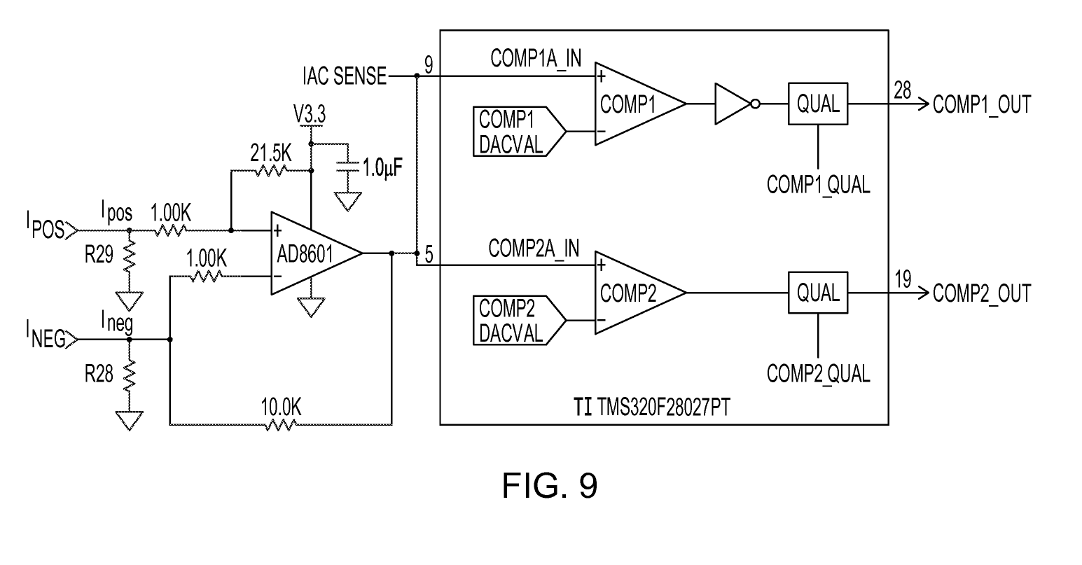

Signals 1A and 1B are a logic level signal (also shown in FIG. 6) with a logical value of 0 or 1. When 1A is hi, MOSFETS Q1 and Q6 are on, and when it is low, MOSFETS Q1 and Q6 are off. Signal /1A is not shown but has the inverse logical value from 1A. Signal 1B is also a logic level signal. When 1B is hi MOSFETS Q2 and Q5 are on and when it is low, MOSFETS Q2 and Q5 are off. There is no time when signals 1A and 1B are both hi. There is always some dead time, when both signals 1A and 1B are low and all four MOSFETS are off. Signals COMP1OUT and COMP2OUT signals generated by the current sense circuit shown in FIG. 9. On the scale used in FIG. 4, COMP1OUT and COMP2OUT occur as a short pulse when it is time to turn off signal 1A or 1B.

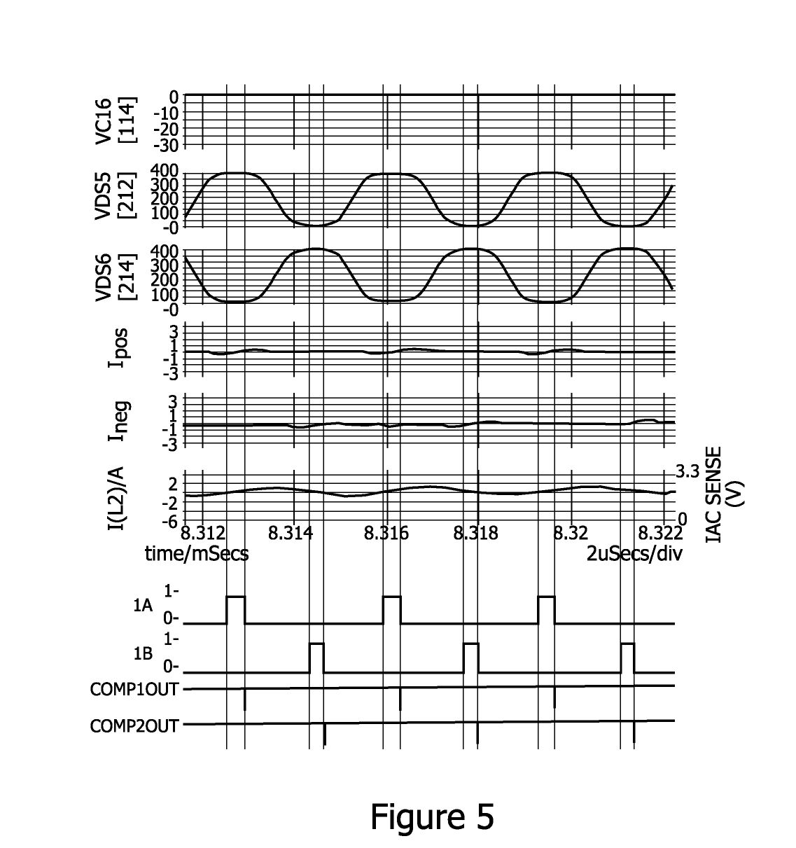

FIG. 5 is an enlarged view of graph 400 where the output waveform of converter 200 is near a zero crossing in the utility voltage 116 waveform. Switching frequency is about 296 kHz and soft switching is clearly maintained.

FIG. 6 is a schematic diagram of an exemplary construction of power converter 200 including controls and connections. MOSFETs Q1, Q2, Q5, and Q6 are shown in place of the switches. In this embodiment, capacitors C21 and C23 are 1000 pF capacitors and capacitor C10 is omitted. The low side bus 203 is connected to control logic ground. The inputs to the control logic are the signals VDSA, VDSB, IACSense. The outputs to drive the MOSFETs Q1, Q6, Q2, and Q5 are 1A, /1A, 1B and /1B.

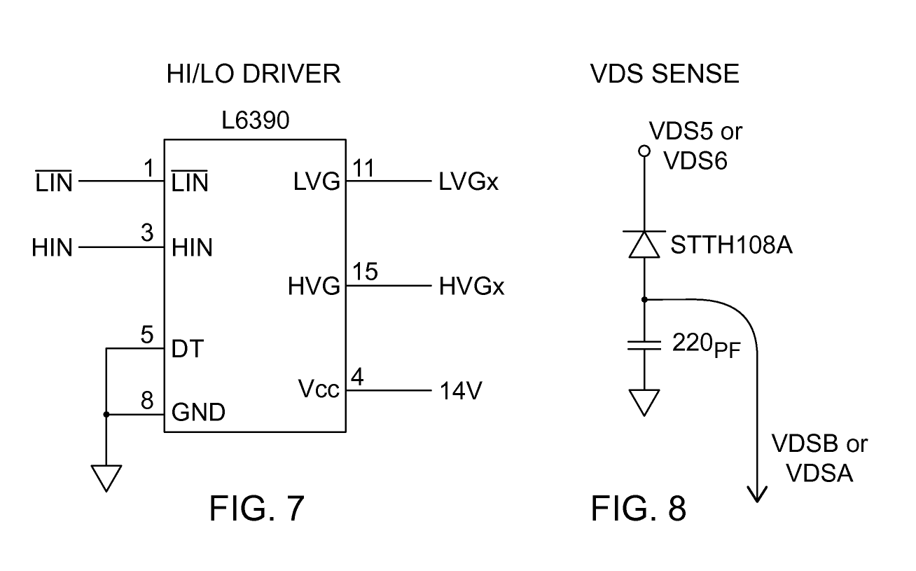

FIG. 7 is a Hi/Lo driver chips for use in the converter 200 shown in FIG. 6. The Hi/Lo driver chip is a ST L6390 MOSFET driver chip available from STMicroelectronics of Geneva, Switzerland. Alternatively, the Hi/Lo driver chip may be any other suitable driver. The ST L6390 converts logic level signals to signals appropriate for MOSFET gate drives. Some detail is omitted, but this is well understood by those skilled in the art of power electronics.

FIG. 8 is a VDS sense circuit for use in the converter 200 shown in FIG. 6. A high voltage diode, STTH108A (available from STMicroelectronics of Geneva, Switzerland), is used to block current from the high voltage circuit from flowing into the low voltage control circuit. In other embodiments, any other suitable high voltage diode may be used. The 220 pF capacitor is included because the high voltage diode has some capacitance that allows excessive signal to propagate at times when VDS5 or VDS6 is experiencing a rapidly changing voltage (i.e., at high dV/dt times). The excess signal is filtered to ground by the capacitor.

FIG. 9 is a schematic diagram of a current sensing circuit for use in the converter 200. The circuit includes an operational amplifier, AD8601, connected to the current sense resistors R28 and R29. A portion of the current sense circuit resides inside the TI TMS320F28027PT control chip (available from Texas Instruments Inc. of Dallas, Tex., USA). The same current sense signal is provided to both comparator inputs, COMP1A_IN and COMP2A_IN. The non-inverting inputs to the comparators are programmed via firmware into the COMP1DACVAL and COMP2DACVAL registers, which are 10 bit digital to analog converters (DACs). By properly programming these register values as described herein, hysteretic current control is achieved. Comparator 1 is configured to have its output inverted. The output of the comparators goes through a digital filtering qualification stage that removes short glitches from the output signal. In the exemplary embodiment, this qualification stage is programmed to 4 processor clocks. The processor is clocked at 24 MHz. The comparator outputs exit the control chip on pins 28 and 19. The comparator outputs, COMP1_OUT and COMP2_OUT, are active low outputs.

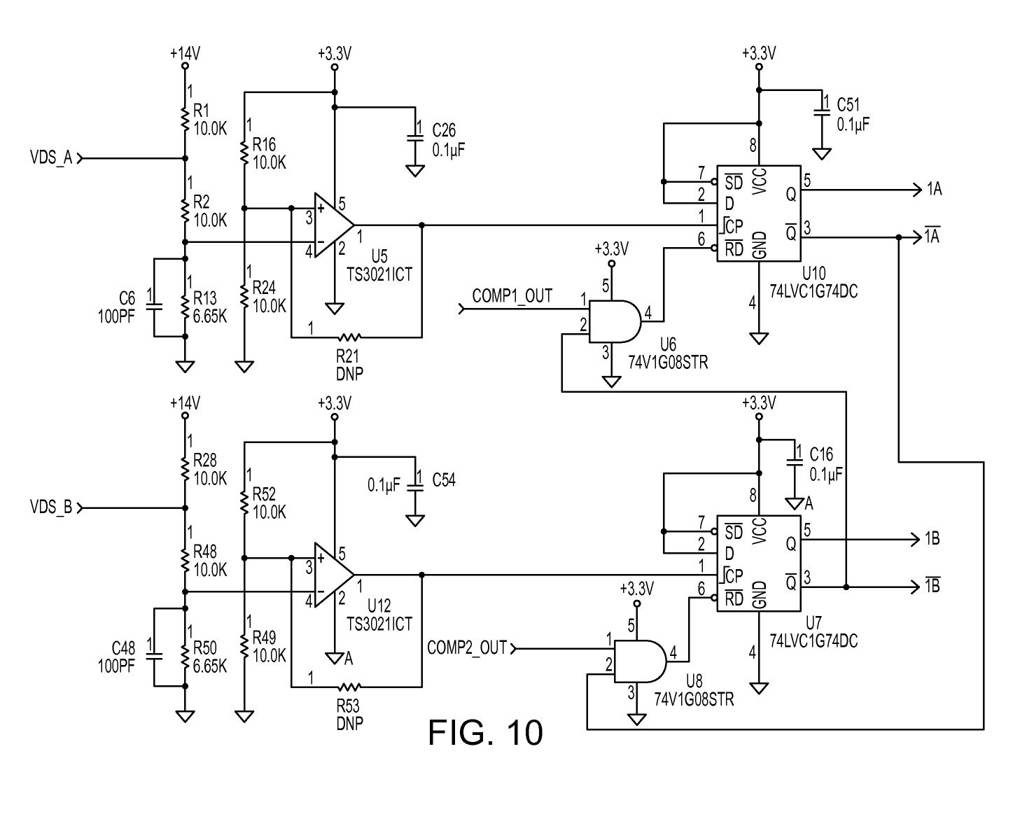

FIG. 10 is a schematic diagram of a remaining portion of the control circuit logic for use in the converter 200 shown in FIG. 6. The VDS sense signals come into a resistor ladder configuration. The VDS comparators create a rising edge output when the VDS signal drops below a certain voltage. The exact voltage is not critical and may be varied to suit different implementations. When the VDS voltage does drop low enough, the comparator creates a rising edge which will clock the corresponding flip flop. The clocked flip flop's Q output will go high and turn on two of the MOSFETs (Q1 and Q6 or Q2 and Q5). However that clock will be ignored if the /RD input to the flip flop is held low. Two AND gates prevent the two Q signals from the flip flops both being high at the same time. This helps protect the H-bridge MOSFETS Q1, Q2, Q5 and Q6 from failure via hardware, sometimes called ‘shoot through’. Both flip flop Q outputs can however be low at the same time, driving all MOSFETs off.

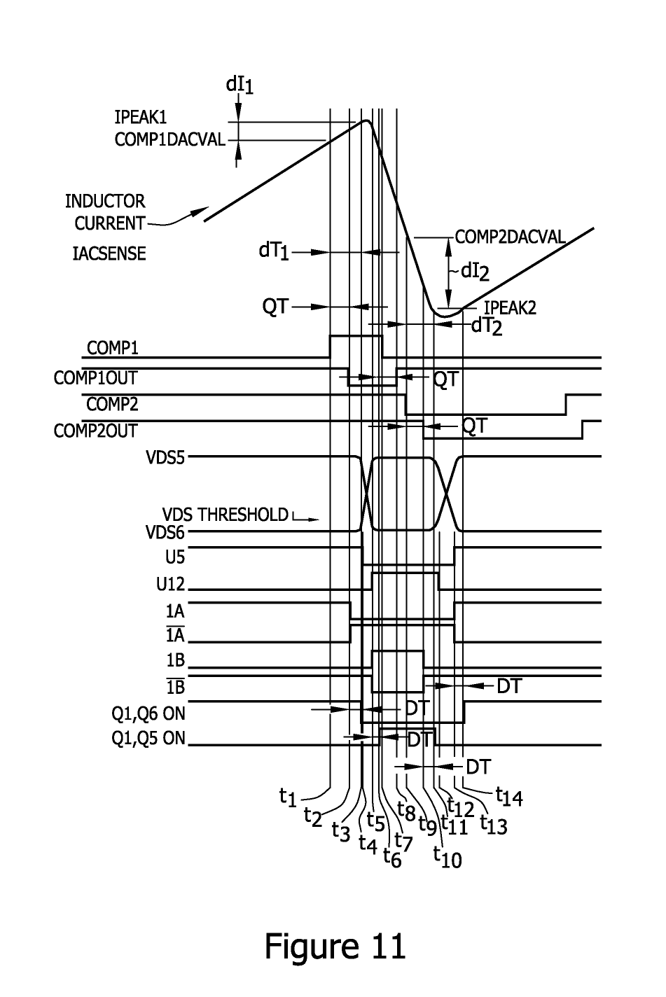

FIG. 11 is a timing diagram that shows details of the current waveform control. FIG. 11 is not drawn to scale, some features are exaggerated so that the timing is more readily viewed. IACSENSE is representative of the high frequency current waveform in inductors L2 and L4. COMP1DACVAL and COMP2DACVAL are the levels at which the COMP1 and COMP2 comparators are programmed to operate. IPEAK1 and IPEAK2 are the actual peak currents that are achieved when the MOSFETs actually turn off. dI1 and dI2 are the differences between the actual peak currents and the programmed COMPxDACVALs.

COMP1 and COMP2 are the signal outputs of the comparators in FIG. 10. COMP1OUT and COMP2OUT are the comparator outputs after qualification. Qualification is a digital filter stage that is used to prevent spurious signals from passing to the output. The qualification stage is programmed to operate with a setting of 4, which prevents the output of the qualification stage from changing state until after the input is stable for 4 clock cycles. Alternatively, any other qualification stage setting may be used. The qualification stage introduces a fixed delay, indicated as QT in FIG. 11, between when the COMPx signal changes state and when the COMPxOUT signal changes state. COMP1 and COMP2 comparators are used to turn off MOSFET pairs (Q1, Q6) and (Q2, Q5) respectively when the desired current levels are reached. In the example embodiment, the qualification time QT is on the order of 167 nanoseconds.

There is a difference between the programmed COMPxDACVALs and the IPEAKx values because of delay between the sensing of when the COMPxDACVALs are hit and when the MOSFETs are actually turned off. dT1 is the time delay between when inductor current rises to the level of COMP1DACVAL, at time t1, and the when Q1 and Q6 turn off, at time t3.

VDS5 is the drain to source voltage across MOSFET Q5. VDS6 is the drain to source voltage across MOSFET Q6. Because Q2 and Q5 are always turned on and off at the same times, and because Q1 and Q6 are also always turned on and off at the same times, drain to source voltage of Q1 is the same as that of Q6, and the drain to source voltage of Q2 is the same as that of Q5. Zero voltage switching of all four MOSFETs is thus achieved through monitoring only the voltages VDS5 and VDS6.

MOSFETs Q1 and Q6 turn off at time t3. At this time the inductor current in L2 is positive, into C16. Because the current is positive and of sufficient magnitude, the inductor current rings with the voltages VDS5 and VDS6 as a resonance between inductors L2 and L4 and C5, C6, C21, C23, C10 and the MOSFET parasitic output capacitances. From time t3 to t5 a natural switching action occurs and zero voltage develops across the next set of MOSFETs to turn on. The body diode in those MOSFETs conducts for a short time while voltage is zero until the MOSFET turns ON. The VDS5 voltage is sensed to have dropped below the VDSTHRESHOLD at time t5. At time t5, the output of comparator U12 goes high to clock flip flop U7, which sets 1B high and /1B low. MOSFETs Q2 and Q5 turn on after delay time DT. Delay time DT is the time delay between setting 1B high and when Q2 actually turns on. The delay time DT is a combination of a delay time through the Hi/Lo Driver chip and the time it takes to charge the MOSFET gate of Q2. In this particular implementation, the dead time DT is on the order of 400 nanoseconds. The delay times, dT1 and dT2, are essentially a fixed delay time equal to QT+DT. In this embodiment, the delay times dT1 and dT2 are approximately 567 nanoseconds.

Time t1 is the time when inductor current rises to the level of COMP1DACVAL. Time t2 is t1+QT and is when COMP1OUT goes low after the COMP1 signal is qualified. Time t3 is the actual time when MOSFETs Q1 and Q6 turn off. At this point the inductor current is no longer rising linearly and starts the resonant switching action described above. At time t4, VDS6 rises above VDSTHRESHOLD causing comparator U5 to go low. At time t5, VDS5 has dropped to the VDSTHRESHOLD and comparator U12 goes high. Comparator U12 goes high, causing signal 1B to go high and /1B to go low. At time t6, Q2 and Q5 turn on, after delay DT from t5. At time t6, the voltage across the inductors has changed polarity and inductor current starts decreasing at a linear rate. Inductor current drops to COMP1DACVAL and COMP1 goes low at time t7. Time t8 occurs after a delay of QT and COMP1OUT goes high. At time t9, inductor current falls to COMP2DACVAL causing COMP2 to go low. Time t10 is when COMP2OUT goes low, QT delay after t9. COMP2OUT going low causes 1B to go low and /1B to go high. MOSFETs Q2 and Q5 turn off at time T11, a delay DT after time t10. At time t11, inductor current stops dropping at a linear rate and begins a resonant switching action similar to that described above, and the voltages VDS5 and VDS6 transition to opposite states. IPEAK2 occurs at time t11. At time t12, VDS5 rises above VDSTHRESHOLD and comparator U12 goes low. At time t13, VDS6 drops below VDSTHRESHOLD causing comparator U5 to go high, which clocks flip flop U10 to drive 1A high and /1A low. At time t14, MOSFETs Q1 and Q6 turn on, starting another linear increase in inductor current.

Using the equations below, one can determine what the values that should be selected for COMP1DACVAL and COMP2DACVAL, to maintain a proper waveform in the output of the converter. dI1 and dI2 are the differences between the actual peak currents and the programmed COMPxDACVALs. dI1 and dT2 are defined by:

dI1=dT1*(v_{—}hv−v_{—}ac)/(L2+L4) (1)

dI2=dT2*(−v_{—}hv−v_{—}ac)/(L2+L4) (2)

where v_hv is the voltage from node 201 to node 203 (shown in FIG. 2), v_ac is the voltage VC16, which is the voltage from node 208 to node 210 (shown in FIGS. 2), and L2 and L4 are the inductance of the two inductors L2 and L4. dT1 and dT2 are fixed delays found by:

dT1=dT2=QT+DT (3)

where QT is the fixed delay introduced by the qualification stage discussed above, and DT is the combination of the delay time through the Hi/Lo Driver chip and the time it takes to charge the MOSFET gates.

The output current of the converter 200 is filtered by capacitor C16 as well as the remainder of the filter elements in filter 110. It is desired to create a sine wave output current, synchronized but with variable phase angle to the AC voltage and frequency generated by the utility grid 116. The average output current of the converter is represented as i_ac. Averaged over one high frequency switching cycle:

i_{—}ac=(IPEAK1+IPEAK2)/2 (4)

where IPEAK1 and IPEAK2 are the actual peak currents that are achieved when the MOSFETs Q1, Q2, Q5, Q6 actually turn off. Given a desired i_ac, values for COMP1DACVAL and COMP2DACVAL must be calculated that will yield the desired output current i_ac. If the desired i_ac is greater than 0 then:

IPEAK2=−IBASE (5)

and

IPEAK1=i_{—}ac*2+IBASE (6)

If the desired i_ac is less than or equal to zero, then:

IPEAK1=IBASE (7)

and

IPEAK2=i_{—}ac*2−IBASE (8)

IBASE determines the type of hysteretic control mode being used. In one embodiment, IBASE is set to a constant 200 milliamps, and thus constant hysteretic control mode is used (CHCM). Alternatively, IBASE may be modulated during the switching cycle to achieve the other control modes described herein.
COMP1DACVAL and COMP2DACVAL may then be determined by:

COMP1DACVAL=IPEAK1−dI1 (9)

COMP2DACVAL=IPEAK2−dI2 (10)

The application of the formulas above allow control of i_ac and removal of the effect that v_hv or v_ac has on i_ac. This may be characterized as feedforward compensation for the control of i_ac. This technique is particularly useful in (but not limited to) a grid tied inverter, where i_ac is desired to be controlled to a clean low distortion sine waveform. In addition, this control works for both positive and negative values of i_ac and v_ac, allowing use as a four quadrant converter capable of sourcing and sinking real and reactive power.

Power conversion systems including soft switching converters as described herein may achieve superior results to known methods and systems. Soft-switching power converters according to the present disclosure operate over wide switching frequencies, which facilitates meeting electromagnetic emission requirements. Moreover, output inductor current sensing for use in soft switching may be achieved relatively simply and inexpensively as compared to some known systems. Soft switching of exemplary converters described herein is further facilitated by monitoring the internal voltages of the converter and delaying turn-on of switches until the voltage has decreased below a threshold voltage. Thus, the exemplary soft switching converters allow high conversion efficiency with lower radiated and conducted emissions. These converters allow for better controlled waveforms thus reducing the probability of component failure due to uncontrolled waveform characteristics, such as high dv/dt or di/dt. Moreover, with well controlled soft switching, the design of output inductors (e.g., L2 and L4) is less critical at high frequency than in a hard switched inverter. Accordingly, inductor windings can overlap more and more interwinding capacitance is allowed, reducing the cost of this component compared to its hard switching counterpart.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A solar power converter comprising:
an inverter input for receiving a direct current (DC) power input;
a first power branch coupled to the inverter input, the first power branch comprising a plurality of first switches and a first current sensor configured to generate a first current signal;
a second power branch coupled to the inverter input, the second power branch comprising a plurality of second switches and a second current sensor configured to generate a second current signal; and
a first output inductor coupled to the first power branch;
a second output inductor coupled to the second power branch;
an inverter output coupled to the first and second output inductors to provide an alternating current (AC) power output; and
a controller configured to control switching of the first and second plurality of switches to provide the AC power output based at least in part on the first and second current signals.

2. The solar power converter of claim 1, wherein the controller is configured to control switching of the first and second plurality of switches to achieve substantially zero voltage switching of the first and second plurality of switches.

3. The solar power converter of claim 2, wherein the controller is configured to control switching of the first and second plurality of switches using current mode control.

4. The solar power converter of claim 3, wherein the controller is configured to operate in a boundary current mode to control switching of the first and second plurality of switches.

5. The solar power converter of claim 3, wherein the controller is configured to operate in a variable hysteresis current mode to control switching of the first and second plurality of switches.

6. The solar power converter of claim 3, wherein the controller is configured to operate in a constant hysteresis current mode to control switching of the first and second plurality of switches.

7. The solar power converter of claim 2, wherein the controller is further configured to monitor a plurality of internal voltages of the solar power converter and delay switching on the first and second plurality of switches until the relevant internal voltage decreases below a voltage threshold.

8. The solar power converter of claim 1, further comprising a DC to DC stage configured to receive DC power from one or more photovoltaic modules and provide DC power to the inverter input, the DC to DC stage coupled to the controller, and the controller configured to control operation of the DC to DC stage to control the DC power provided to the inverter input.

9. The solar power converter of claim 8, further comprising a non-electrolytic capacitor coupled between the DC to DC stage and the inverter input.

10. A photovoltaic system comprising a photovoltaic module coupled to the solar power converter of claim 1.

11. A solar power converter comprising:
an inverter input for receiving a direct current (DC) power input;
a first power branch coupled to the inverter input, the first power branch comprising a plurality of first switches;
a second power branch coupled to the inverter input, the second power branch comprising a plurality of second switches; and
a first output inductor coupled to the first power branch;
a second output inductor coupled to the second power branch;
an inverter output coupled to the first and second output inductors to provide an alternating current (AC) power output; and
a controller configured to monitor a plurality of internal voltages of the solar power converter, and configured for current mode control of the first and second plurality of switches to provide the AC power output based at least in part on the monitored internal voltages.

12. The solar power converter of claim 11, wherein the controller is configured to control switching of the first and second plurality of switches to achieve substantially zero voltage switching of the first and second plurality of switches.

13. The solar power converter of claim 11, wherein the controller is configured to operate in a boundary current mode to control switching of the first and second plurality of switches.

14. The solar power converter of claim 11, wherein the controller is configured to operate in a variable hysteresis current mode to control switching of the first and second plurality of switches.

15. The solar power converter of claim 11, wherein the controller is configured to operate in a constant hysteresis current mode to control switching of the first and second plurality of switches.

16. The solar power converter of any of claims 11, wherein the first power branch includes a first current sensor configured to generate a first current signal representative of a first power branch current of the solar power converter, the second power branch includes a second current sensor configured to generate a second current signal representative of a second power branch current of the solar power converter.

17. The solar power converter of claim 16, further comprising a DC to DC stage configured to receive DC power from one or more photovoltaic modules and provide DC power to the inverter input, the DC to DC stage coupled to the controller, and the controller configured to control operation of the DC to DC stage to control the DC power provided to the inverter input.

18. The solar power converter of claim 17, further comprising a non-electrolytic capacitor coupled between the DC to DC stage and the inverter input.

19. A photovoltaic system comprising a photovoltaic module coupled to the solar power converter of claim 17.

20. The solar power converter of claim 1, wherein the controller is configured to control switching of the first and second plurality of switches at a switching frequency greater than a frequency of the AC power output.

21. The solar power converter of claim 20, wherein the controller is configured to control switching of the first and second plurality of switches at a switching frequency greater than about twenty kilohertz.

22. The solar power converter of claim 11, wherein the controller is configured to control the first and second plurality of switches at a switching frequency greater than a frequency of the AC power output.

23. The solar power converter of claim 22, wherein the controller is configured to control the first and second plurality of switches at a switching frequency greater than about twenty kilohertz.

24. The solar power converter of claim 1, wherein the controller is configured to selectively control switching of the first and second plurality of switches to operate the solar power converter as a power source or a power sink.

25. The solar power converter of claim 24, wherein the controller is configured to selectively control switching of the first and second plurality of switches to operate the solar power converter to source or sink real power.

26. The solar power converter of claim 25, wherein the controller is configured to selectively control switching of the first and second plurality of switches to operate the solar power converter to source or sink reactive power.

27. The solar power converter of claim 24, wherein the controller is configured to selectively control switching of the first and second plurality of switches to operate the solar power converter to source or sink reactive power.

28. The solar power converter of claim 11, wherein the controller is configured to selectively control the first and second plurality of switches to operate the solar power converter as a power source or a power sink.

29. The solar power converter of claim 28, wherein the controller is configured to selectively control the first and second plurality of switches to operate the solar power converter to source or sink real power.

30. The solar power converter of claim 29, wherein the controller is configured to selectively control the first and second plurality of switches to operate the solar power converter to source or sink reactive power.

31. The solar power converter of claim 28, wherein the controller is configured to selectively control the first and second plurality of switches to operate the solar power converter to source or sink reactive power.
